(19) United States
(12) Patent Application Publication
(10) Pub. No.: US 2011/0299119 A1
(43) Pub. Date: Dec. 8, 2011

(54) IMAGE FORMING APPARATUS

(75) Inventors: Ken MIYAZAKI, Sagamihara-shi (JP); Takemasa Ikeda, Tokyo (JP)

(73) Assignee: KONICA MINOLTA BUSINESS TECHNOLOGIES, INC., Tokyo (JP)

(21) Appl. No.: 13/151,384

(22) Filed: Jun. 2, 2011

(30) Foreign Application Priority Data
Jun. 8, 2010 (JP) JP2010-130724

(51) Int. Cl. G06K 15/00; G03G 15/00

(52) U.S. Cl. 358/1.15; 399/12

(57) ABSTRACT

An image forming apparatus including: at least one replaceable part constituting the image forming apparatus; and a control section for controlling the replaceable part, wherein the control section is provided with a plurality of replacement standards for one replaceable part, and performs a replacement standard process in conformance to each of these replacement standards.

The present application is based on Patent Application No. 2010-130724 filed at the Japan Patent Office on Jun. 8, 2010 and which is hereby incorporated herein in its entirety.

### TECHNICAL FIELD

The present invention relates to an image forming apparatus for forming an image according to image data, particularly to an image forming apparatus provided with one or more replaceable component parts, wherein the component part replacement interval is placed under management.

### BACKGROUND

In an image forming apparatus such as a printer, facsimile, photocopier and multi-functional peripheral for forming an image according to image data and transferring the same onto a sheet of paper, a latent image is formed on a photoconductor according to image data and is developed by a developer. Then this image is transferred onto a sheet of paper directly or through a transfer section. This image forming apparatus includes a document reading section for reaching a document, a photoconductor, a writing section for writing a latent image onto the photoconductor, a development section for developing a latent image, a transfer section for transferring the image of the photoconductor onto a sheet of paper, an intermediate transfer section, a fixing section for fixing the image having been transferred onto the sheet, and other components. These components must be replaced due to deterioration resulting from long-term use, or must be replaced on a periodic basis.

Replaceable parts are normally replaced by service personnel (customer engineer). However, users may be requested to replace some of the replaceable parts that can be replaced with comparative ease and safety. The parts replacement service by users (ORU-M: Operator Replaceable Unit-Management) is already known in the conventional art. Replacement of parts by users according to the ORU-M method reduces the machine downtime, and cuts down the service cost. This method provides some use's with an economical service menu.

In the conventional user ORU-M service having been offered so far, however; user replaceable parts are fixed in advance. The replacement unit is also fixed for each model. This cannot allow the number of ORU parts to be increased or decreased according to the way of operation by the user, or permit the replacement unit to be switched between the unit replacement and parts unit replacement according to the country or region. This arrangement fails to provide a service suited to individual users. To solve this problem, a proposal of Japanese Patent Application Publication No. 2009-69638 is disclosed. Japanese Patent Application Publication No. 2009-69638 discloses a procedure that is intended to provide the optimum service in conformance to the particular requirements in the user's implementation form, country and region, wherein a replacement implementation method (periodic replacement or replacement at the time of trouble) or replacement personnel (service personnel/user) can be selected for each set of a plurality of replaceable parts.

In the replacement standard representing the upper limit of the replacement parts of the disclosed procedure, however, the user and service are based on one and the same standard. Thus, when the replacement standard has been reached, the machine is kept in the standby mode until the spare units are prepared by the service personnel, and this may cause a production loss in some cases. Especially when the stock has run short on the part of the service personnel, there will be an increase in the loss suffered by the user. Further, even if the replacement standard has not been met, a user meticulous about image quality may want to maintain the best image quality by replacement. Further, although the network infrastructure has been improved, some users do not wish to link an image forming apparatus to the global network for the purpose of security. Only after having visited the maintenance site, do the service personnel recognize that the time for replacement has already come. Thus, the service personnel are faced with urgent problems awaiting immediate solution. It may be difficult to meet the days schedule.

The present invention is intended to solve the aforementioned problems. It is accordingly an object of this invention to provide an image forming apparatus wherein downtime due to part replacement is reduced and the load on the service personnel is minimized.

### SUMMARY

1. To achieve at least one of the abovementioned objects, an image forming apparatus reflecting one aspect of the present invention comprises at least one replaceable part constituting the image forming apparatus; and a control section for controlling the replaceable part, wherein the control section is provided with a plurality of replacement standards for one replaceable part, and performs a replacement standard process in conformance to each of these replacement standards.

2. In the abovementioned image forming apparatus of item 1, wherein the replaceable part comprises an user replaceable parts.

3. In the abovementioned image forming apparatus of item 1, wherein the plurality of replacement standards are made up of replacement set values different from each other.

4. In the abovementioned image forming apparatus of item 1, further comprising: a display section controlled by the control section, wherein the control section notifies replacement of the replaceable part corresponding to each of the replacement standards to the display section.

5. In the abovementioned image forming apparatus of item 1, wherein the control section notifies replacement of the replaceable part corresponding to at least one of the plurality of replacement standards to an external device linked with the image forming apparatus through a network.

6. In the abovementioned image forming apparatus of item 1 further comprising: an input section controlled by the control section, wherein this control section allows the replacement standards to be set by an operator using the input section.

7. In the abovementioned image forming apparatus of item 1, wherein the control section contains information on a service life of the replaceable parts, in addition to the replacement standards.

8. In the abovementioned image forming apparatus of item 1 further comprising: a storage section for storing the replacement standards as data.

9. In the abovementioned image forming apparatus of item 1, wherein, when one of the replacement standards for one of the replacement parts is set, the control section determines other replacement standards in response to the replacement set value corresponding to the set replacement standard.

10. In the abovementioned image forming apparatus of item 1, wherein, when one of the replacement standards for one of the replacement parts is set, the control section requests an operator to set other replacement standards in response to the replacement set value corresponding to the set replacement standard.

11. In the abovementioned image forming apparatus of item 1, wherein, when one of the replacement standards for one of the replacement parts is set, the control section notifies the set replacement standards to an external device linked with the image forming apparatus through a network.

12. In the abovementioned image forming apparatus of item 1, wherein the control section allows the replacement standards to be set by the external device linked with the image forming apparatus through a network.

13. In the abovementioned image forming apparatus of item 1, wherein the replacement standards comprise a service replacement standard and a replacement standard except a service personnel.

14. In the abovementioned image forming apparatus of item 13, wherein the control section restricts setting of the service replacement standard except the service personnel.

15. In the abovementioned image forming apparatus of item 13, wherein the service replacement standard and replacement standard except the service personnel meet a relationship of:

(Service replacement standard)≦(Replacement standard except the service personnel)

16. In the abovementioned image forming apparatus of item 13, wherein the replacement standard except the service personnel represents an user replacement standard.

17. In the abovementioned image forming apparatus of item 16, wherein the control section allows a user to set the user replacement standard.

18. In the abovementioned image forming apparatus of item 13, wherein the control section divides the replaceable parts into non-user replaceable parts and user replaceable parts, allows only the service replacement standard to be set for the non-user replaceable parts, and allows the service replacement standard and/or the replacement standard except the service personnel to be set for the user replaceable parts.

19. In the abovementioned image forming apparatus of item 1, wherein the replacement standard relates to hours of using relevant replaceable parts and the number of using thereof.

### BRIEF DESCRIPTION OF THE DRAWINGS

FIG. 1 is a diagram representing an example of the structure of an image forming apparatus in an embodiment of the present invention;

FIG. 2 is a block diagram representing an example of the structure of an image forming apparatus in an embodiment of the present invention;

FIG. 3 is a conceptual diagram showing a storage space in a nonvolatile memory of the image forming apparatus in an embodiment of the present invention;

FIG. 4a is a conceptual diagram showing a storage space in a nonvolatile memory of a specific example in the image forming apparatus in an embodiment of the present invention;

FIG. 4b is a conceptual diagram showing a storage space in a nonvolatile memory of a specific example in the image forming apparatus in an embodiment of the present invention;

FIG. 5 is also a conceptual diagram showing a storage space in a nonvolatile memory of a specific example in the image forming apparatus in an embodiment of the present invention;

FIG. 6 is a diagram representing a setting screen for setting the replacement standard in the operation section in the image forming apparatus in an embodiment of the present invention;

FIG. 7 is a diagram representing a setting screen for setting the replacement standard value in the operation section in the image forming apparatus in an embodiment of the present invention;

FIG. 8 is a diagram representing a variation of the setting screen for setting the replacement standard value in the operation section in the image forming apparatus in an embodiment of the present invention;

FIG. 9 is a diagram representing an alarm display on the setting screen for setting the replacement standard value in the operation section of the image forming apparatus in an embodiment of the present invention;

FIG. 10 is a flow chart showing the replacement standard processing procedure of the image forming apparatus in an embodiment of the present invention;

FIG. 11 is a flow chart showing the service notification procedure at the time of processing the replacement standard in the image forming apparatus in an embodiment of the present invention;

FIG. 12a is a diagram showing an alarm screen when the replacement standard has been reached in the image forming apparatus in an embodiment of the present invention;

FIG. 12b is a diagram showing an alarm screen when the replacement standard has been reached in the image forming apparatus in an embodiment of the present invention; and

FIG. 13 is a flow chart showing another example of processing the replacement standard in the image forming apparatus in an embodiment of the present invention.

### DESCRIPTION OF THE PREFERRED EMBODIMENTS

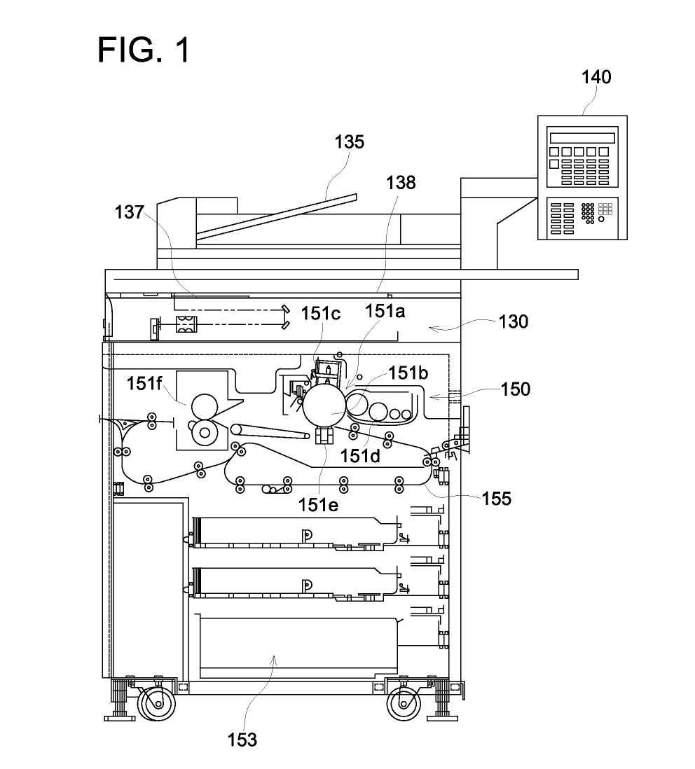

The following describes an embodiment of the present invention. FIG. 1 is a central sectional area representing the overall configuration of the image forming apparatus. It shows a mechanical structure. The following describes the structure:

The upper portion of the image forming apparatus 1 is provided with a scanner section 130 including a CCD 131, and a flow-in type automatic document feed apparatus (ADF) 135. This is capable of reading an image of the document through an ADF document reading slit glass 137 or platen glass 138. The image reading section of the scanner section is formed of the aforementioned scanner section 130, flow-in type automatic document feed apparatus (ADF) 135, ADF document reading slit glass 137, platen glass 138 and others. The upper portion of the image forming apparatus 1 without a platen glass 138 provided thereon has an operation section 140 including a touch panel that permits operation by the operator and allows information to be displayed.

The lower portion of the image forming apparatus 1 is provided with a plurality of sheet feed trays 153 (illustrated in three tiers). A sheet conveyance path 155 for conveying sheets supplied from the sheet feed tray, and others are incorporated inside the main body of the image forming apparatus. An image forming section 151 consisting of an LD section 151a, photoconductor 151b, charging device 151c, developing device 151d, transfer section 151e and fixing device 151f is provided along the sheet conveyance path 155. The image forming section 151, sheet feed tray 153, sheet conveyance path 155 and others constitute the printer section 150 of the present invention.

The charging device 151c, developing device 151d and transfer section 151e are arranged around the photoconductor 151b. The charging device 151c uniformly charges the surface of the photoconductor 151b before image writing. The LD section 151a applies a semiconductor laser to the photoconductor 151b having its surface uniformly charged, whereby an electrostatic latent image is formed on the photoconductor 151b. The developing device 151d uses a toner member to develop the electrostatic latent image formed on the photoconductor 151b by the LD section 151a. This development process ensures a toner image to be formed on the photoconductor 151b. The transfer section 151e transfers the toner image of the photoconductor 151b onto the sheet fed from the sheet feed tray 153. The sheet with a toner image transferred thereon is separated from the photoconductor 151b, and is conveyed to the fixing device 151f. The toner member remaining on the photoconductor 151b is removed by a cleaning section. The fixing device 151f ensures that the toner image transferred onto the surface of the sheet is fixed by heating the sheet having been conveyed with an image formed thereon.

In the image forming apparatus, component parts such as the document reading section for reading a document, photoconductor, LD section, development section, transfer section, and fixing section are subjected to deterioration due to long-time use, and are designed to be replaceable. Some of these components (ORU: Operator Replacement Unit) are easily mounted and dismounted so that they can be replaced by the operator.

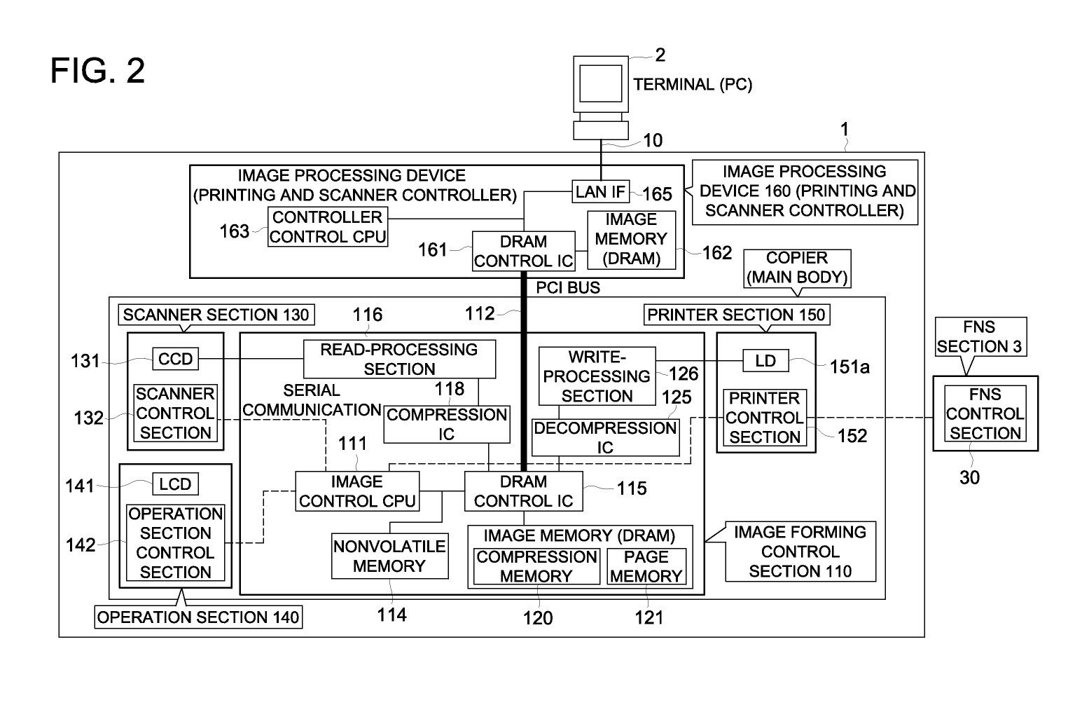

FIG. 2 is an overall block diagram showing an image forming apparatus 1 and an image forming system with the terminal 2 and FNS section 3 connected to the image forming apparatus. The details are shown below.

The image forming apparatus 1 includes an image forming control section 110, scanner section 130, operation section 140 and printer section 150. The image forming apparatus 1 is also provided with an image processing device (printing and scanner controller) 160 that processes the image data inputted from the terminal 2 such as a terminal through the LAN 10, and ensures that the image data obtained from the scanner section 130 is transmitted to the terminal 2 through the LAN 10.

The image forming control section 110 is provided with the PCI bus 112 linked to the image processing device (printing and scanner controller) 160, and the PCI bus is connected with the DRAM control IC 115. The DRAM control IC 115 is connected with the image memory (DRAM) consisting of a compression memory 120 and page memory 121. The compression memory 120 stores the compressed image data and the page memory 121 temporarily stores the non-compressed image data to be printed prior to image formation. The image data acquired by the image processing device (printing and scanner controller) 160 is sent to the DRAM control IC 115 through the PCI bus 112 with the progress of printing operations.

The image forming control section 110 is provided with an image control CPU 111. This image control CPU 111 is linked with the DRAM control IC 115. The image control CPU 111 is connected with the nonvolatile memory 114 consisting of a flash memory and others. This nonvolatile memory 114 incorporates the initial print setting information of the image forming apparatus 1, machine setting information such as a process control parameter, data on the service life of component parts, one or more than two replacement standards value for each of the replaceable parts, identification of each of the replaceable parts to distinguish between user replaceable parts or non-user replaceable parts, and hysteresis of use (hours of using the relevant replaceable parts and the number thereof) for each of the replaceable parts in such a way that these pieces of information can be read. Thus, the nonvolatile memory 114 corresponds to the storage section of the present invention. The user replaceable parts are assumed to be replaceable by the user, and are designed, for example, so that they can be easily mounted or dismounted from the apparatus. Some of the non-user replaceable parts do not assume replacement by the user, and some others cannot be replaced by the user.

The image control CPU 111 reads the nonvolatile data of the nonvolatile memory 114, and writes the desired data into the nonvolatile memory 114. The image control CPU 111 controls the operation of each component of the image forming apparatus 1 in conformity to the aforementioned machine setting information and print setting information. The image control CPU 111 constitutes the control section of the present invention control section.

The scanner section 130 is provided with a CCD 131 for optical reading and a scanner control section 132 for overall control of the scanner section 130. The scanner control section 132 is connected with the image control CPU 111 to ensure serial communication with each other. Further, the CCD 131 is connected to the read-processing section 116 for processing the image data read by the CCD 131. The read processing section 116 is connected to the DRAM control IC 115 so as to be controlled.

The operation section 140 combines the functions of both the display section and input section of the present invention, and is provided with an LCD 141 made of a touch panel and an operation section control section 142 for overall control of the operation section. This operation section control section 142 is connected with the image control CPU 111 to allow serial communication to be made with each other. Under the control of the image control CPU 111, the operation section 140 permits inputting of the machine settings, including a change in the settings of the replacement standard value of the replaceable parts, and setting of the operation control conditions, using the LCD 141. The operation section 140 also allows the settings of the information on the sheets (size and paper type) to be inputted for each of the sheet feed trays. Under the control of the image control CPU 111, the operation section 140 displays notifications on the replacement of the replaceable parts and various forms of other information.

Further, the DRAM control IC 115 is linked with a compression IC 118 and a decompression IC 125 for compression and decompression of the image data, respectively. The write-processing section 126 is connected with the image forming section 151 provided with an LD 151a of the printer section 150 and others, and is used to process the write data used to operate the LD section 151a. The printer section 150 includes a sheet feed tray 153 and sheet conveyance path 155 in addition to the aforementioned image forming section 151. Further, the printer section 150 has a printer control section 152 for overall control of the printer section 150 (with respect to paper feed, image formation, paper ejection and finishing). The printer control section 152 is connected to the aforementioned image control CPU 111. The printer control section 152 operates in conformity to the control command of the image control CPU 111, and controls the printer section 150. The printer control section 152 is connected with the FNS control section 30 for overall control of the FNS section 3 that is a finishing device. The FNS section 3 is controlled through the printer control section 152. FNS section 3 applies such a finishing operation as stapling or punching operations to the sheet ejected from the image forming apparatus 1, whenever required.

The PCI bus 112 connected with the DRAM control IC 115 is connected with the DRAM control IC 161 of the image processing device (printing and scanner controller) 160. When the image forming apparatus is used as a network printer or network scanner, the image processing device (printing and scanner controller) 160 receives image data and others from the terminal 2 and others connected to the LAN 10, by means of the image forming apparatus 1. The image processing device also sends the image data from the scanner section 130, to the terminal 2 connected to the LAN 10. In the image processing device (printing and scanner controller) 160, the DRAM control IC 161 is connected with the image memory 162 composed of a DRAM and others. Further, in the image processing device (printing and scanner controller) 160, the aforementioned DRAM control IC 161, controller control CPU 163 for overall control of the image processing device (printing and scanner controller) 160, and LAN interface 165 are connected to a common bus. The LAN interface 165 is connected to the LAN 10. Further, an external device such as a sewer for the image forming apparatus service can be connected through the LAN 10 or network (not illustrated), although not illustrated. In this case, the image control CPU 111 allows communication with the external device.

The following describes the basic operation of the image forming apparatus 1. The image data storing procedure in the image forming apparatus 1 will be shown first. The following describes how an image is read by the scanner section 130 and how image data is generated in the first image forming apparatus 1. In the scanner section 130, an image is optically read from the document by the CCD 131. In this case, the operation of the CCD 131 is controlled by the scanner control section 132 that receives commands from the image control CPU 111. The document can be read by feeding the document into the flow-in type automatic document feed apparatus (ADF) 135, or by placing the document on the platen glass 138.

The image control CPU 111 is operated in conformity to a program, and issues a command to the scanner section 130 according to the operation of the operation section 140. The image read by the CCD 131 is subjected to data processing by the read-processing section 116. The processed image data is compressed by the compression IC 118, and is then stored in the compression memory 120 through the DRAM control IC 115.

Further, the image data is inputted into the image forming apparatus 1 through the LAN 10. The aforementioned image data is exemplified by the data generated by the application program of terminal 2 and the data generated by another image forming apparatus. This data is received by the image processing device (printing and scanner controller) 160 through the LAN 10 and LAN interface 165, and is once stored in the image memory 162 by the DRAM control IC 161. The data stored in the image memory 162 is sent to the DRAM control IC 115 through the PCI bus 112, and is once stored in the page memory 121. The data stored in the page memory 121 is sent to the compression IC 118 through the DRAM control IC 115 and is compressed there. This data is then stored in the compression memory 120 through the DRAM control IC 115.

When an image is to be outputted from the image forming apparatus 1, the data stored in the compression memory 120 is sent to the decompression IC 125 through the DRAM control IC 115, wherein the data is decompressed. The data is then sent to the write-processing section 126 and the write data is generated. The data is then written to the photoconductor 151b in the LD section 151a.

In the printer section 150, the sheet feed tray 153, sheet conveyance path 155 and other sections are controlled by the printer control section 152 having received the command from the image control CPU 111. In the printer section 150, image formation, transfer of the image on the sheet, fixing of the image, conveyance of the sheet to the FNS section 3 along the sheet conveyance path and finishing by the FNS section 3 are carried out sequentially, with the result that the printed sheet is outputted.

In the operation of the aforementioned apparatus, the image control CPU 111 controls the hysteresis of use in terms of hours of using the apparatus or the replaceable parts, and the number of replaceable parts to be used. The hysteresis of use is updated, depending on the operation hours and the number of parts to be used. The hysteresis of use is stored in the nonvolatile memory 114. The image control CPU 111 allows two or more replacement standards to be set for part of or all of the replacement parts. This setting can be made in the step of the initial setting operation or in the step of the setting operation to be inputted by the operator.

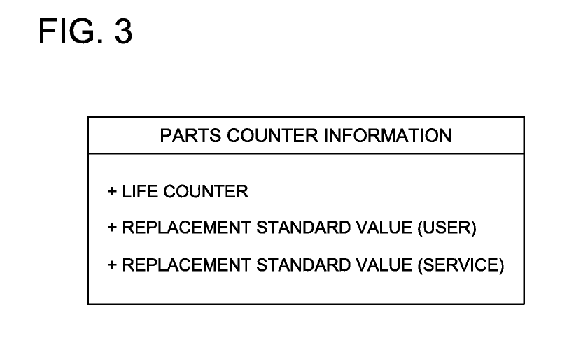

FIG. 3 shows a concept of the space for storing the parts counter information in the nonvolatile memory. The parts counter information storage space includes the counter information for identifying the conditions of using the replacement parts, the information known under the popular name of a life counter, the replacement standard value as a user replacement standard, and the information on the replacement standard value that is a service replacement standard.

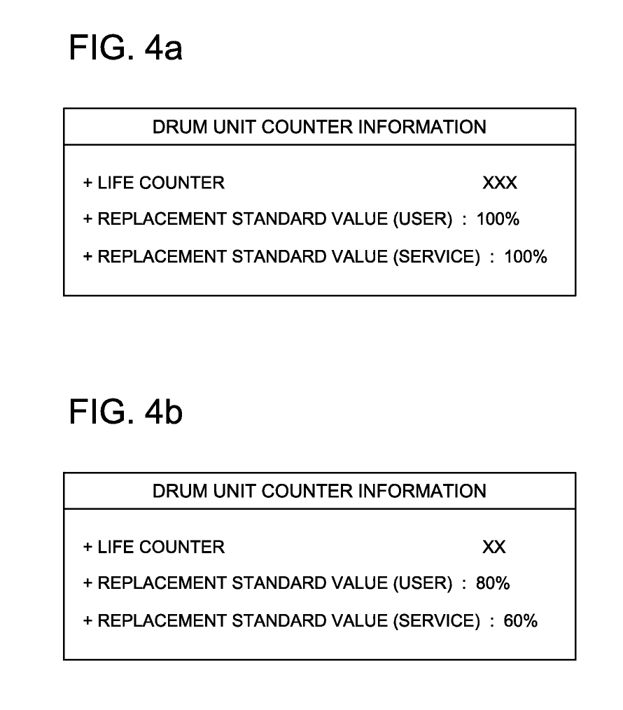

FIG. 4 shows the concept of the space for storing the drum unit counter information as a specific example of the parts counter information. In this example, the replacement standard is set in terms of percentage with respect to the information on the service life of each of the component parts. The life counter is incremented by one for each printing operation. The count is compared with the replacement standard and is used as the numerical value indicating the service life of the parts.

FIG. 4a indicates the storage space in the initial setting. Both the user replacement standard and the service replacement standard are set at 100 percent. These standards can be set at a numerical value smaller than the information on the service life of the parts, for example, at 90 percent as an initial setting. The information on the service life of the parts can be included as one replacement standard other than the aforementioned two or more replacement standards. The information on the service life of parts is usually stored as a fixed value in the nonvolatile memory 114.

FIG. 4b shows that the user replacement standard and the service replacement standard each are set at a value smaller than 100 percent. Each of the replacement standards is assumed as having been set by the operation input. In the diagram, the user replacement standard is set at 80 percent and the service replacement standard is set at 60 percent. For example, if the durability (service life) of the drum unit is 300,000 prints, the user replacement standard will come to 240,000 prints and the service replacement standard will come to 180,000 prints.

A high quality required by the user can be obtained by setting the replacement standard at a time earlier than the expiration of the service life of the component part. Further, if the service replacement standard is set at a time earlier than the user replacement standard, the service replacement standard (e.g., 180,000 prints) is reached before the user replacement standard (e.g., 240,000 prints) is reached. This is notified by the personnel in charge of service, with the result that replacement parts can be procured earlier, or other necessary measures can be taken in advance.

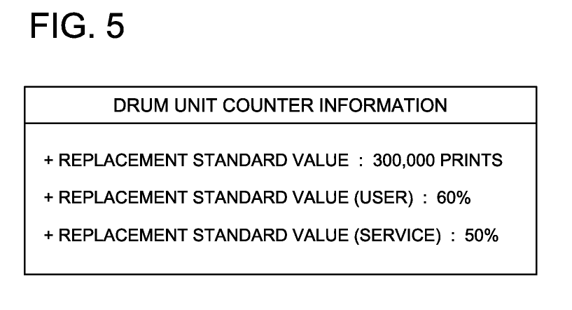

Depending on the requirements of the user, the personnel in change of service can set the user replacement standard, and the service replacement standard can be set in conformity to this standard for user replacement. For example, a certain user without any space for accommodating a replacement drum unit may wish to have the parts to be replaced at the end of 180,000 prints in order to keep the image quality at a higher level. For this purpose, the service personnel makes the settings when installing a machine, as shown in FIG. 5. To be more specific, a value of 60 is stored in the area of the user replacement standard in the nonvolatile memory, and a value of 50 is stored in the area of the service replacement standard. In FIG. 5, the service life of the parts (300,000 prints) is indicated as one replacement standard. The replacement interval will come to 60 percent of the replacement standard value (300,000 prints) that corresponds to 180,000 prints, with respect to the replacement standard for the service life of these parts, as desired by the user. Further, with consideration given to preparation for procurement of the parts for the service, 50 percent, i.e., 150,000 prints indicate the time for parts procurement. The service personnel are notified of the replacement interval when 150,000 prints have been implemented. This allows a maintenance schedule to be created at the time of placing an order for parts. A new drum is sent to the user when 60 percent has been reached. This reduces the waste with minimum downtime. It is also possible to make such arrangements that only the user replacement standard is set for the user replaceable parts. In this case, a plurality of replacement standards for users can be set, as exemplified by the first user replacement standard, the second user replacement standard, and so on.

The user replaceable parts have been used in the above explanation. Similarly, two or more replacement standards can also be set for the non-user replaceable parts as well. If the service replacement standard is used as the replacement standard, a plurality of the replacement standards for service personnel can be set, as shown by the first service replacement standard, the second service replacement standard and so on. In this case, if some of the replacement standards for service personnel can be set by the user, the service personnel can be urged to replace the parts at replacement intervals desired by the user, although replacement by the user is not assumed. Further, if some of the replacement standards for service personnel can be set only by the service personnel, a standard convenient for the service personnel can be set. In this case, it is preferred to meet the following relationship:

[Service replacement standard that can be set by the user]>[Service replacement standard that can be set only by the service personnel]

The following Table shows an example of the setting/operation relationship for the user replaceable parts and non-user replaceable parts.

TABLE 1

| | User operation | User operation | |
|---|---|---|---|
| | allowed | not allowed | |
| User | Replacement | Replacement | Replacement |
| replaceable | standard value | standard value | by user |
| parts | for user | for service | allowed |
| | | personnel | |
| Non-user | 1st replacement | 2nd replacement | Replacement |
| replaceable | standard value | standard value | by user |
| parts | for service | for service | not allowed |
| | personnel | personnel | |

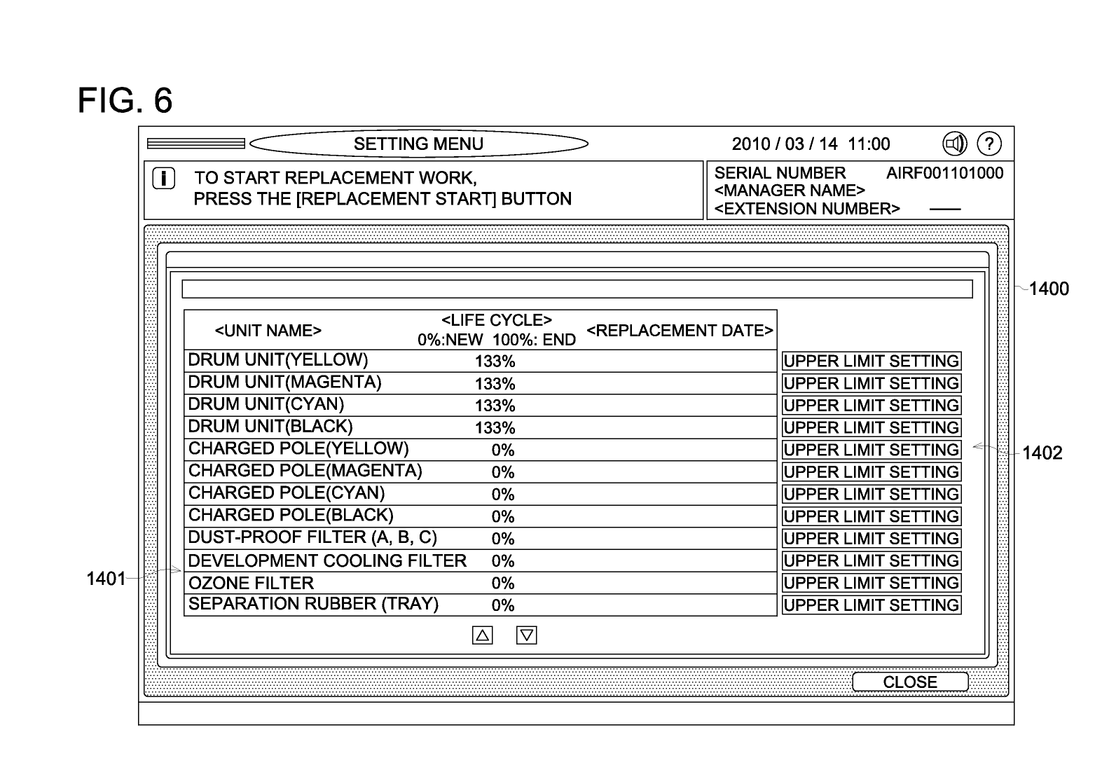

The following describes an example of the replacement standard setting screen in the operation section 140. FIG. 6 shows a setting menu screen 1400. This screen gives a display list 1401 showing the unit name and life cycle, and upper limit setting button 1402 corresponding to the units in such a way that this list and buttons can be operated to input a command. “0 percent” in the life cycle of the display list 1401 indicates a new product, and “100 percent” indicates a product with its service life having been expired. The screen shifts to the upper limit setting screen corresponding to the relevant unit by depressing a desired item of a desired unit in the display list 1401 and depressing the upper limit setting button 1402 corresponding to that unit.

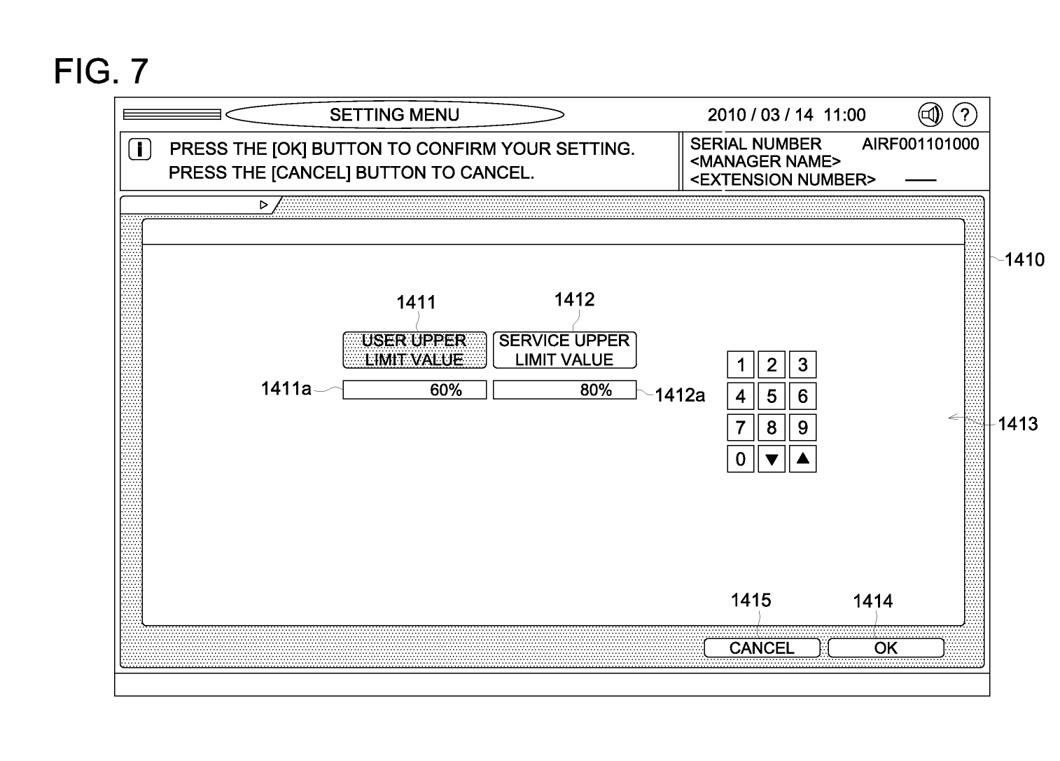

FIG. 7 shows the upper limit setting screen 1410, which is given on the operation section 140. The upper limit setting screen 1410 shows the user upper limit button 1411 for selecting the operation input for the user replacement standard, and the service upper limit button 1412 for selecting the operation input of the service replacement standard in such a way that these buttons can be operated. Further, the numeric keypad 1413 for inputting the replacement standard value, the OK button 1414 for confirming the setting, and the cancel button 1415 for canceling the setting are displayed so that they can be operated to input a command. This screen is designed in such a way that the replacement standard is inputted in terms of percentage. However, the screen can be designed as an operation screen wherein a command is inputted in terms of the number of prints. The present invention is not restricted to any of these configurations. This upper limit setting screen 1410 is used to select either the user upper limit button 1411 or service upper limit button 1412, and the numeric keypad 1413 is used to input a numerical value. The numerical value having been inputted is represented by a percentage in the user upper limit display column 1411a or service upper limit display column 1412a. If the OK button 1414 is selected, the replacement standard value for users or service having been selected is accepted, and is stored in the nonvolatile memory 114. If the cancel button 1415 is pressed, the replacement standard value having been inputted is canceled.

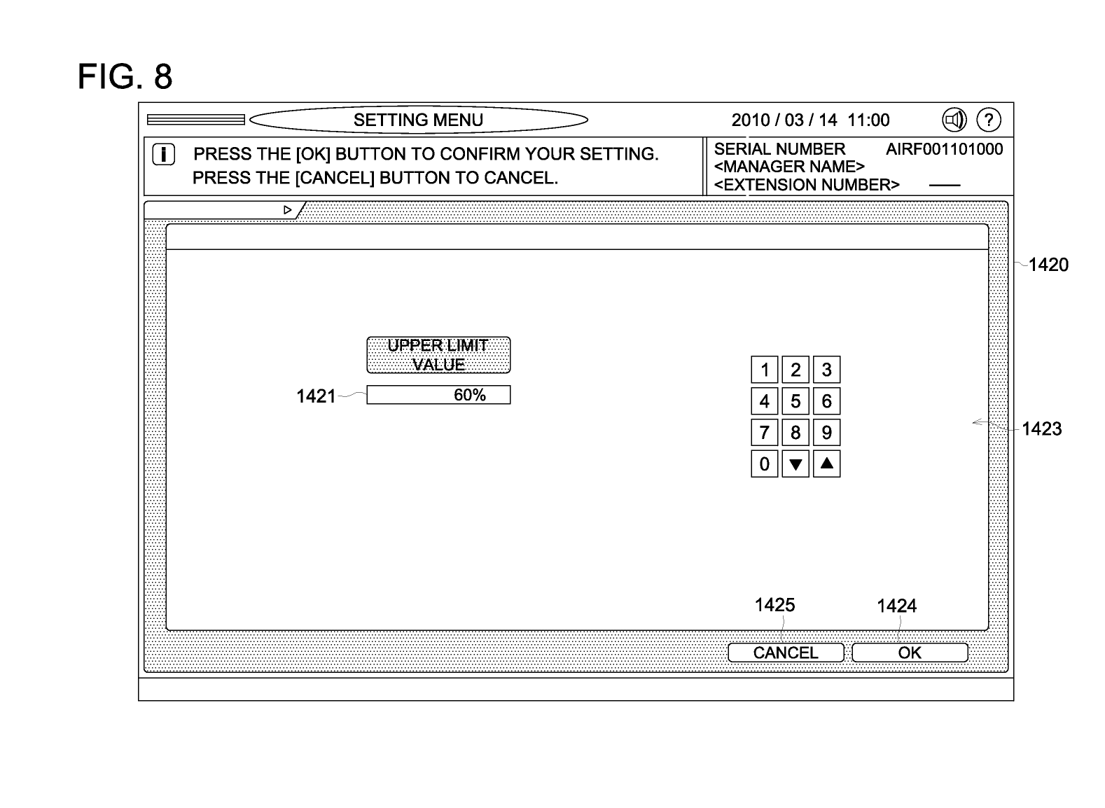

FIG. 8 is an example showing a variation of the upper limit setting screen. This upper limit setting screen 1420 allows only the user replacement standard to be inputted, for example. Thus, the upper limit setting screen shows the numeric keypad 1423, the upper display column 1421 representing the numerical value having been inputted, the OK button 1424 for confirming the setting, and the cancel button 1425 for canceling the settings so that they can be operated to input a command. If the user replacement standard is set and the OK button 1424 is pressed on this upper limit setting screen 1420, the user replacement standard is accepted and the service replacement standard is automatically set in response to the user replacement standard having been set. For example, if the service replacement standard is set at 80 percent with respect to the user replacement standard, the service replacement standard will be set at 64 percent when the user replacement standard has been set at 80 percent. Further, the following calculation can be used. This will maintain the relationship between the user replacement standard and service replacement standard having the same differences:

(New service upper limit)=(User upper limit after input)−{(User upper limit before input)−(Previous service upper limit)}

When the replacement standard values are divided between those for user replaceable parts and those for non-user replaceable parts, the operation of the upper limit button of the aforementioned setting screen 1420 can be configured in such a way that the user upper limit is inputted for user replaceable parts, while the service upper limit is inputted for non-user replaceable parts. In this case, it is also possible to make such arrangements that, for the user upper limit, the aforementioned calculation formula is used to set the service upper limit, and, for the service upper limit, the same value is set as the user upper limit.

When the service replacement standard and user replacement standard are to be set as two or more replacement standards, these standards should be set in such a way that the service replacement standard does not exceed the user replacement standard. This is because the service replacement standard must be met first in order to ensure that the condition of the parts consumption is notified to the service personnel in advance so that the parts are procured or prepared by the service personnel. The image control CPU 111 can be designed to provide control in such a way as to impose a restriction on the setting if the aforementioned relationship fails to be met.

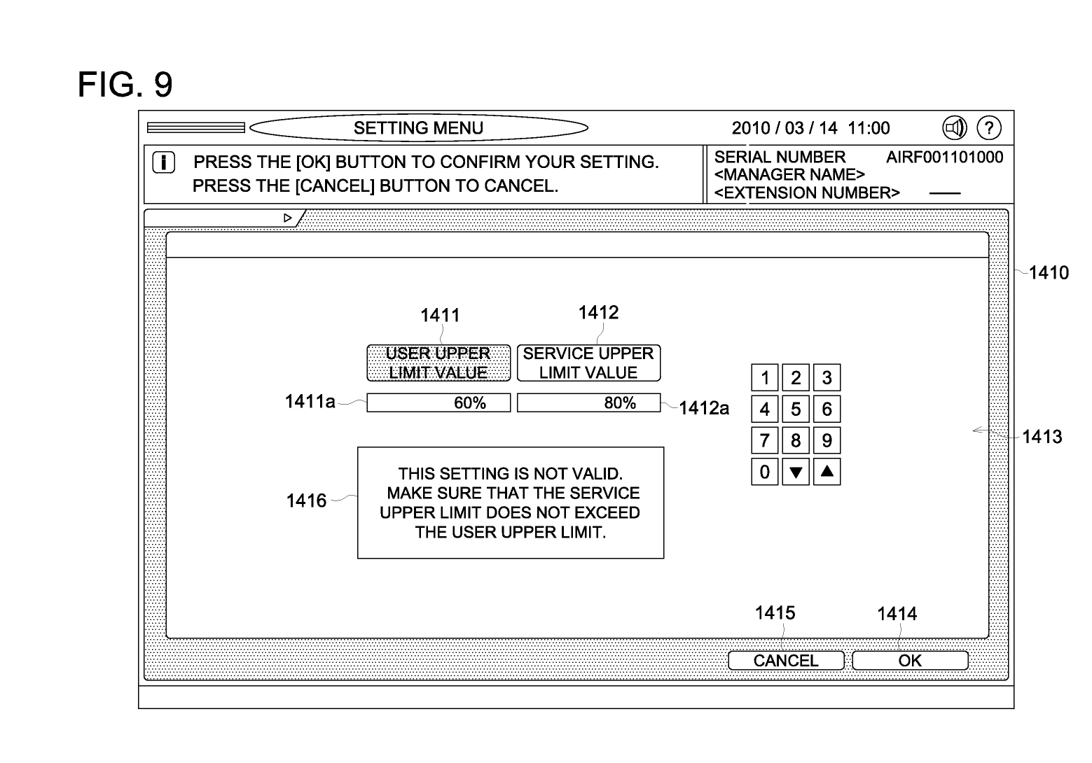

FIG. 9 shows how the user replacement standard and service replacement standard are set on the upper limit setting screen 1410. In this setting, the input will be given so that the service replacement standard is reached later than the user replacement standard, as shown in the user upper limit display column 1411a and service upper display column 1412a. This does not ensure that the service personnel correctly identify the condition of the parts consumption in advance. To solve this problem, if the input information fails to meet the conditions wherein the service replacement standard is equal to or less than the user replacement standard, the image control CPU 111 allows an alarm 1416 to be displayed on the setting screen so as to disable the setting of this input, as shown in FIG. 9. Further, means can be provided to ensure that the service upper limit is automatically made equivalent to the user upper limit. In this case, it is preferred to notify the operator that the service upper limit has been automatically made equivalent to the user upper limit.

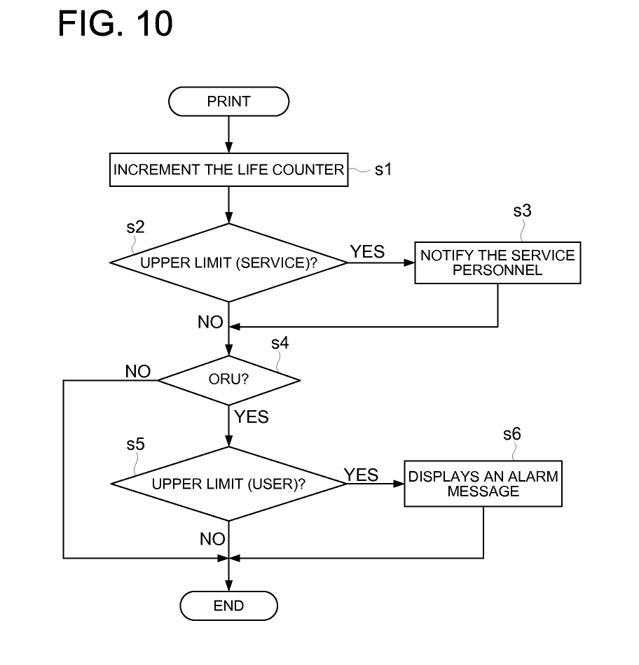

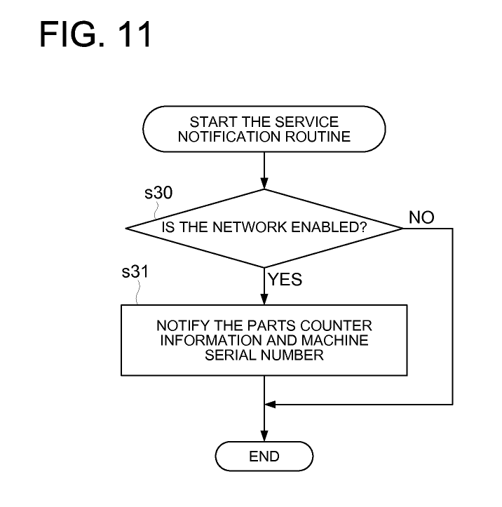

Referring to the flow chart of FIG. 10 and FIG. 11, the following describes the replacement standard procedures for some replaceable parts when two or more replacement standards are set. The following processing is implemented by the image control CPU 111. The life counter is incremented by +1 for each print in the process of image formation (Step s1). Then, based on the updated life counter, a step is taken to determine if the upper limit (service) as the service replacement standard has been reached or not (Step s2). If the upper limit has been reached (Yes in Step s2), this is notified to the service personnel (Step s3). FIG. 11 shows the details of the procedure for notifying the service personnel. In this case, the notification can be given to the operation section 140.

As shown in FIG. 11, in the process of notifying the service personnel, a step is taken to determine if connection to the network has been made or not (Step s30). If the connection to the network has been completed (Yes in Step s30), the parts counter information and machine serial number are notified to the terminal of the service personnel and the server through the network (Step s31). If connection to the network has not been made (No in Step s30), the processing terminates. In this case, it is preferred that an alarm display should be given on the screen for the service personnel to ensure that visiting service personnel can immediately determine if the service replacement standard has been reached or not.

If the life counter has not reached the aforementioned upper limit (service) in Step s2 (No in Step s2), a step is taken to determine whether or not the relevant replaceable parts are ORUs (Operator Replaceable Units) (Step s4). If they are not ORUs (No in Step s4), the processing terminates. If these parts are ORUs (Yes in Step s4), a step is taken to determine whether or not the life counter has reached the user replacement standard (Step s5). If the replacement standard is not reached (No in Step s5), the processing terminates. If the replacement standard has been reached (Yes in Step s5), an alarm message is displayed on the operation section 140 (Step s6), and the processing terminates.

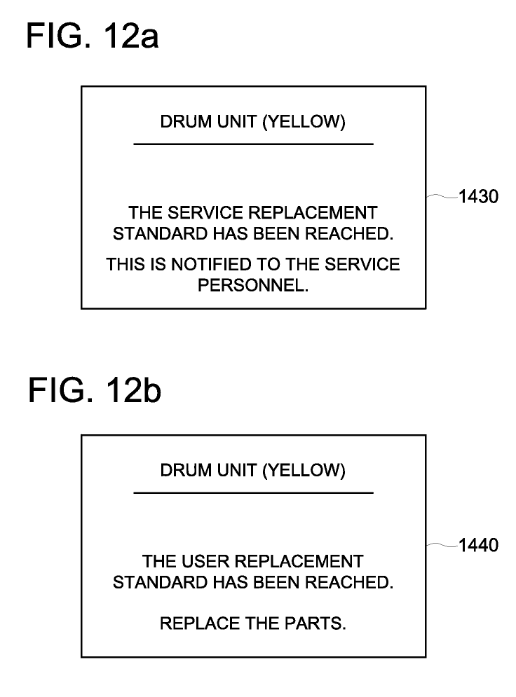

FIG. 12 shows an example of the alarm display in the operation section 140. FIG. 12a shows that the notice screen 1430 is displayed on the operation section 140 when the service replacement standard has been reached and the service personnel are notified of this. This allows the user to understand that the service personnel have been notified of the current status. FIG. 12b shows that the notice screen 1440 is displayed on the operation section 140 when the user replacement standard has been reached. This permits the user to recognize the relevant parts that need replacement.

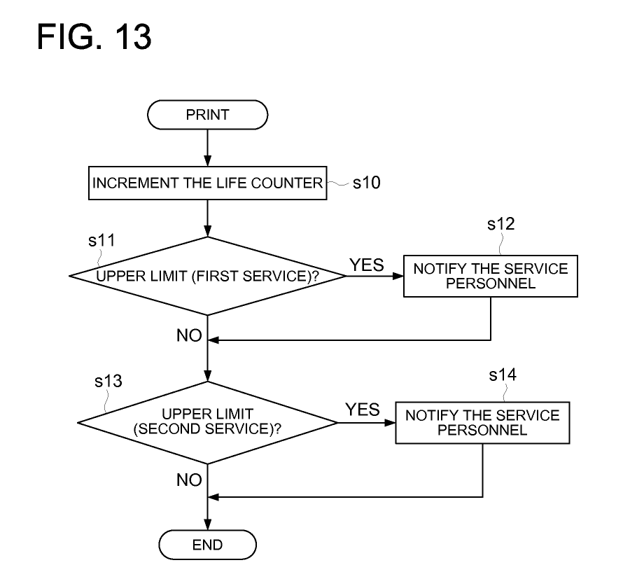

The aforementioned description of the processing procedure assumes that the service replacement standard and user replacement standard have been set as two or more replacement standards. In the present invention, however, two or more service replacement standards can be set, as described above. The following describes the processing procedure with reference to the flow chart of FIG. 13. The following description is based on the assumption that the first service replacement standard and the second service replacement standard (wherein the first replacement standard is smaller than the second replacement standard) have been set.

The life counter is incremented by +1 for each print in the process of image formation (Step s10). Then, based on the updated life counter, a step is taken to determine if the upper limit (the first service) as the first service replacement standard has been reached or not (Step s11). If the upper limit has been reached (Yes in Step s11), this is notified to the service personnel (Step s12). FIG. 11 shows the details of the procedure for notifying the service personnel. This is done by the same procedure as the procedure shown with reference to FIG. 11. In this case, the notice is given in such a way that the distinction can be made between the notice of the first service and the notice of the second service. In the notice of the first service, the service personnel are allowed to prepare the replacement parts, to check the current stock or to place an order if there is no stock.

If the life counter has not yet reached the aforementioned upper limit (the first service) (No in Step s11), a step is taken based on the life counter to determine whether or not the upper limit (the second service) as the second service replacement standard has been reached (Step s13). If the upper limit has been reached (Yes in Step s13), a step is taken to notify the service personnel (Step s14). In the notice of the second service, the service personnel can take steps to start the replacement of parts. If the upper limit has not been reached (No in Step s13), the processing terminates.

As described above, even when a plurality of the service replacement standards are set, processing can be implemented in conformity to each of the replacement standards. This reduces the workload of the service personnel and eliminates the possibility of downtime.

The embodiments of the present invention have been described with reference to the aforementioned embodiments. It is to be expressly understood, however, that the present invention is not restricted thereto. The present invention can be embodied in a great number of variations with appropriate modifications or additions, without departing from the scope of the invention claimed.

The image forming apparatus of the present embodiment is provided with one or more replaceable parts constituting the apparatus and a control section for controlling these replaceable parts. This control section has two or more replacement standards for each of the replaceable parts, and performs processing in conformance to each of the replacement standards.

According to the present embodiment, two or more replacement standards are provided for each replaceable part. This enables control to be made in conformity to the user replacement standard and service user replacement standard that are different from each other, for example. This allows the user to determine his own replacement standard to ensure high image quality, and permits the service personnel to take steps including preparation for replacement parts in conformance to the user replacement standard, with the result that downtime for part replacement is reduced and the load of the service personnel is minimized. When the user wants to set up his own replacement standard, he can determine a replacement standard for the user replaceable parts (ORU).

It is only required that the aforementioned two or more replacement standards can be controlled independently of one another. These standards can have the same replacement set value or different replacement set value. The replacement set value can be set according to hours of using the relevant replaceable parts and the number thereof.

The processing of a replacement standard in conformance to two or more replacement standards includes notification of the replacement to the display section and notification to the external device connected to the image forming apparatus through the network. The same processing can be implemented independently according to two or more replacement standards or different processing can be implemented according to each replacement standard. It is also possible to make such arrangements that, when one of the replacement standards has been set, other replacement standards are automatically set in conformity to the predetermined rule in response to the set value or, when one of the replacement standards has been set, the operator is required to set other replacement standards in response to the set value. In the aforementioned rule, other replacement standards can be determined at a prescribed ratio with respect to one replacement standard having been set, or other replacement standards can be determined with a prescribed difference.

The aforementioned two or more replacement standards may include the value that can be set by the operator in the operation section, in addition to the fixed value. The fixed value and set value are allowed to coexist. The replacement standard value having been set can be stored in the storage section. The storage section can be exemplified by a flash memory as a nonvolatile memory and HDD. Further, the replacement standard having been set can be notified to the external device linked to the image forming apparatus through the network. This arrangement allows the service personnel to identify the replacement standard, and the setting can be identified by the management server. Further, an external device can be configured to send a command to the image forming apparatus in such a way that other replacement standards will be set in response to the replacement standard having been notified.

The two or more replacement standards exemplified above include the service replacement standard and replacement standards for other than the service personnel. A user replacement standard is illustrated to represent the replacement standard other than the service replacement standard. The aforementioned service replacement standard preferably imposes restrictions on the setting by other than the service personnel. An external device such as a server for service purposes connected to the personal computer or image forming apparatus through the network can be mentioned for the side of the service personnel. This restriction ensures that only the standard convenient to the service personnel can be set as the service replacement standard. The restrictions imposed on the setting can be exemplified by the method of enabling the service replacement standard to be inputted and set only when the operator has inputted the service personnel code and others, or the method of enabling only the setting made by the aforementioned server for service purposes. Further, the replacement standards for other than the service personnel permit inputting and setting operations to be performed by the user.

In the aforementioned case, the service replacement standard and replacement standard for other than the service personnel preferably meet the following requirement as replacement values:

(Service replacement standard)≦(Replacement standard for other than the service personnel)

When the service replacement standard does not exceed the other replacement standard, the service personnel is allowed to prepare or procure the replacement parts. More preferably, the following requirement is met:

(Service replacement standard)<(Replacement standard for other than the service personnel)

Hours of using the relevant replaceable parts and the number thereof can be used to represent the aforementioned replacement values. In this case, the aforementioned service replacement standard may refer to the non-user replaceable parts wherein replacement by the user is not assumed, while the replacement standard for other than the service personnel may refer to the user replaceable parts where replacement by the user is enabled.

It is also possible to make such arrangements that the replaceable parts are divided into non-user replaceable parts and user replaceable parts, and these replacement standards are made different from each other so that each of these standards can be set independently. For example, it is also possible to arrange such a configuration that only the service replacement standard can be set for the non-user replaceable parts, and the service replacement standard and/or replacement standard for other than the service personnel can be set for the user replaceable parts. If setting of the service replacement standard alone is allowed for the non-user replaceable parts, setting by the user is allowed in a portion of the service replacement standard, while only the setting by the service personnel is allowed in other portions of the service replacement standards.

As described above, the image forming apparatus of the present invention includes one or more replaceable parts constituting the aforementioned apparatus, and a control section for controlling these replaceable parts, wherein the control section is provided with two or more replacement standards for one replaceable part, and replacement standard processing is performed in conformance to each of these replacement standards. This arrangement allows the user to set up a replacement standard as desired, thereby ensuring high image quality to be maintained. Further, this arrangement also permits service personnel to prepare the replacement parts and to take other preparatory action in conformance to the user's replacement standard. This arrangement also ensures improved productivity and effective procurement and preparation of parts, and eliminates the need of keeping excess quantities in stock.

What is claimed is:

1. An image forming apparatus comprising:
at least one replaceable part constituting the image forming apparatus; and
a control section for controlling the replaceable part,
wherein the control section is provided with a plurality of replacement standards for one replaceable part, and performs a replacement standard process in conformance to each of these replacement standards.

2. The image forming apparatus of claim 1,
wherein the replaceable part comprises an user replaceable parts.

3. The image forming apparatus of claim 1,
wherein the plurality of replacement standards are made up of replacement set values different from each other.

4. The image forming apparatus of claim 1 further comprising:
a display section controlled by the control section,
wherein the control section notifies replacement of the replaceable part corresponding to each of the replacement standards to the display section.

5. The image forming apparatus of claim 1,
wherein the control section notifies replacement of the replaceable part corresponding to at least one of the plurality of replacement standards to an external device linked with the image forming apparatus through a network.

6. The image forming apparatus of claim 1 further comprising:
an input section controlled by the control section, wherein this control section allows the replacement standards to be set by an operator using the input section.

7. The image forming apparatus of claim 1,
wherein the control section contains information on a service life of the replaceable parts, in addition to the replacement standards.

8. The image forming apparatus of claim 1 further comprising:
a storage section for storing the replacement standards as data.

9. The image forming apparatus of claim 1,
wherein, when one of the replacement standards for one of the replacement parts is set, the control section determines other replacement standards in response to the replacement set value corresponding to the set replacement standard.

10. The image forming apparatus of claim 1,
wherein, when one of the replacement standards for one of the replacement parts is set, the control section requests an operator to set other replacement standards in response to the replacement set value corresponding to the set replacement standard.

11. The image forming apparatus of claim 1,
wherein, when one of the replacement standards for one of the replacement parts is set, the control section notifies the set replacement standards to an external device linked with the image forming apparatus through a network.

12. The image forming apparatus of claim 1,
wherein the control section allows the replacement standards to be set by the external device linked with the image forming apparatus through a network.

13. The image forming apparatus of claim 1,
wherein the replacement standards comprise a service replacement standard and a replacement standard except a service personnel.

14. The image forming apparatus of claim 13,
wherein the control section restricts setting of the service replacement standard except the service personnel.

15. The image forming apparatus of claim 13,
wherein the service replacement standard and replacement standard except the service personnel meet a relationship of:
(Service replacement standard)≦(Replacement standard except the service personnel)

16. The image forming apparatus of claim 13,
wherein the replacement standard except the service personnel represents an user replacement standard.

17. The image forming apparatus of claim 16,
wherein the control section allows a user to set the user replacement standard.

18. The image forming apparatus of claim 13,
wherein the control section divides the replaceable parts into non-user replaceable parts and user replaceable parts, allows only the service replacement standard to be set for the non-user replaceable parts, and allows the service replacement standard and/or the replacement standard except the service personnel to be set for the user replaceable parts.

19. The image forming apparatus of claim 1,
wherein the replacement standard relates to hours of using relevant replaceable parts and the number of using thereof.
